(19) United States
(12) Patent Application Publication
(10) Pub. No.: US 2006/0261933 A1
(43) Pub. Date: Nov. 23, 2006

(54) Vehicle performance data communication link

(75) Inventors: Jean-Christophe Deniau, Fenton, MI (US); Jorge A. Vazquez-Murillo, Zapopan (MX); Alexander L. Kyllmann, Zapopan (MX)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens VDO Automotive Corporation, Auburn Hills, MI (US)

(21) Appl. No.: 11/437,146

(22) Filed: May 19, 2006

Related U.S. Application Data
(60) Provisional application No. 60/683,541, filed on May 20, 2005.
(60) Provisional application No. 60/702,522, filed on Jul. 26, 2005.

(51) Int. Cl. B60R 25/10

(52) U.S. Cl. 340/426.15; 340/426.2

(57) ABSTRACT

A method and device for communicating data indicative of vehicle performance includes a method of generating a low frequency wireless link between a module within a vehicle and a cellular communication device disposed within that vehicle. The cellular communication device such as a cell phone is part of a network thereby eliminating the need to create an additional network connection with the vehicle. Data indicative of vehicle operating conditions is transmitted through the cellular network to a remote facility for processing, scheduling and notification of an operator. The wireless link between the module disposed within the vehicle and a wireless communication device provides for early notification and scheduling of maintenance of the vehicle to maintain desired operating parameters and conditions.

### CROSS REFERENCE TO RELATED APPLICATION

The application claims priority to U.S. Provisional Application No. 60/683,541 which was filed on May 20, 2005 and U.S. Provisional Application No. 60/702,522 which was filed on Jul. 26, 2005.

### BACKGROUND OF THE INVENTION

This invention generally relates to vehicle diagnostic systems. More particularly, this invention relates to a method of communicating vehicle diagnostic information to a remote location.

Automobiles and other modern vehicles are controlled at least partially by electronic controls that receive information from a plurality of sensors and other devices installed throughout the vehicle. A controller receives information from the sensors that is utilized to control the vehicle operations. Further, the controller utilizes the sensors to detect faults in various operating systems. The controller typically includes a connection port where a diagnostic computer can be connected to receive information indicative of vehicle performance or fault conditions such as a trouble code, for example. The information received from the controller such as the trouble code aids a technician in service and repair of the vehicle.

Disadvantageously, vehicle performance parameters such as the trouble codes that are communicated through the physical connection made between the diagnostic computer and the controller require an operator to bring the vehicle to a service center. Failure of a vehicle system is often predictable based on changes in performance parameters. Shifts in operating performance are not necessarily detectable by an operator and therefore can go unnoticed. In many instances, the fault is not of such a magnitude as to alert an operator, and continues without remedy. As appreciated, small problems easily fixed, if unattended can result in large problems that are more difficult and costly to remedy.

Accordingly, it is desirable to design and develop a diagnostic system that provides early notification of a possible failure of a vehicle system.

### SUMMARY OF THE INVENTION

An example vehicle performance data link includes a device that is disposed within the vehicle that collects information indicative of vehicle performance. This information is then transmitted through a low frequency wireless link to a wireless communication device such as a cellular phone disposed within the vehicle. The cellular phone transmits this information through to a central customer care or maintenance facility where this data is processed.

The example method utilizes an existing cellular or other wireless communication link to transmit information indicative of vehicle conditions. In this manner a separate communication device and link is not required to be installed within a vehicle. Instead the vehicle will include a device that will transmit through a low frequency wireless link data indicative of vehicle performance to the existing communication device. The communication device such as a cellular phone utilized by the operator of the vehicle is then utilized to transmit through a cellular network or other communication network the vehicle performance data to a central facility. The central facility will then utilize the vehicle performance data to determine if maintenance is required.

The determination of maintenance can be simply communicated to the operator of the vehicle that a detected trouble code has been transmitted and the vehicle requires services. Further, raw data indicative of vehicle performance may also be transmitted and then analyzed at the central location to determine if maintenance is required within a desired time period. In this way, preventive maintenance can be scheduled and performed prior to a failure of a vehicle system that would require and causes undesired and unscheduled down time.

Accordingly, the system and method according to this invention utilizes existing communication devices to transmit vehicle performance data utilized to communicate trouble codes and schedule maintenance to prevent undesired and unscheduled vehicle failures.

These and other features of the present invention can be best understood from the following specification and drawings, the following of which is a brief description.

### BRIEF DESCRIPTION OF THE DRAWINGS

FIG. 1 is a schematic representation of a vehicle including an example device according to this invention.

FIG. 2 is a schematic representation of a system and method according to this invention for communicating vehicle diagnostic information to a central location.

### DETAILED DESCRIPTION OF THE PREFERRED EMBODIMENT

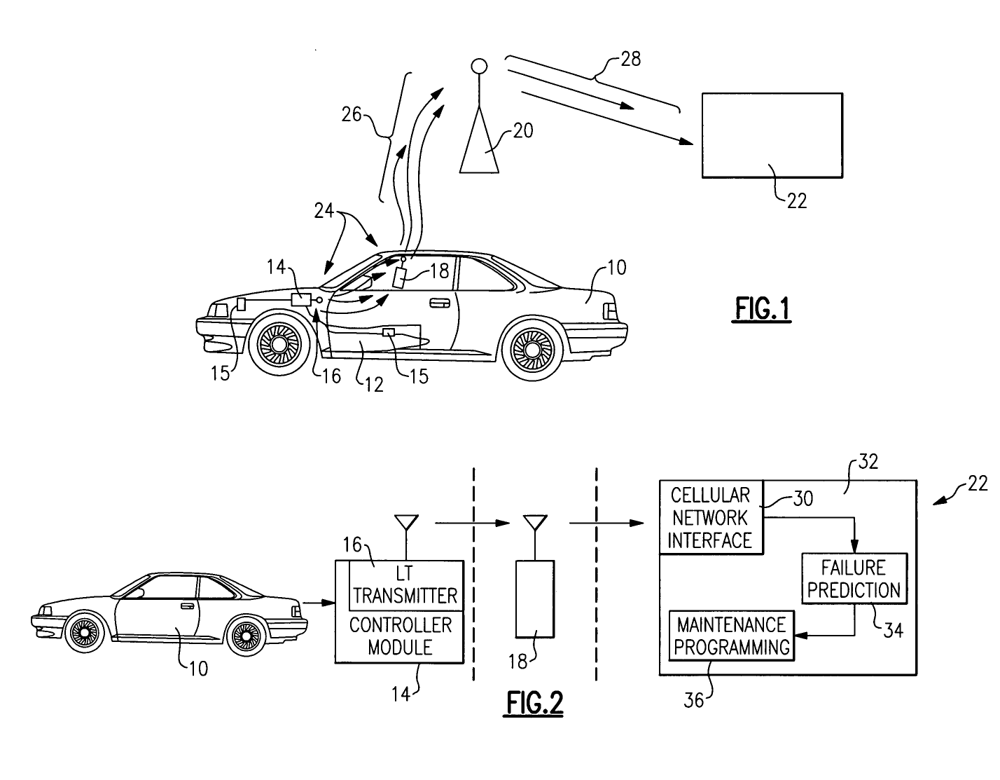

Referring to FIG. 1, an example vehicle 10 is illustrated including a vehicle system 12 such as an engine, transmission or suspension system. The system 12 is monitored by a plurality of sensors 15 or other devices that obtain and measure data that is indicative of performance and operation of the vehicle 10. This information is routed to a module 14. The example module 14 includes a low frequency (LF) antenna 16. The LF antenna 16 generates a low frequency link with a communication device disposed within the vehicle 10. In the illustrated example communication device is a cellular phone 18 carried by an operator of the vehicle. The cellular phone 18 provides a link to a communication network 20. The communication network 20 then transmits a signal to a desired remote location 22. The remote location 22 can be a service center or any other center that is designed and set up to receive the data sent from the vehicle 10.

The example module 14 receives data indicative of vehicle performance and can either pass along this data or generate a data trouble code that is indicative of a defined fault condition of one of the vehicle systems 12. This data is transmitted to the remote location 22 through the cellular network 20 and is communicated to a dealer or other maintenance facility.

The example module 14 generates a low frequency wireless link such as a Bluetooth transmission. This LF transmission is of a configuration that is common to many devices. The cellular phone 18 is configured to receive such communications. As appreciated, the low frequency wireless link such as the Bluetooth communication is designed to provide a communication link to other such capable devices within a limited area. Accordingly, the module 14 is not required to include the devices or systems that are required to communicate with the cellular network 20. Further, most cellular networks 20 require a paid subscriptions or other identification requiring a subscription and incurring an additional cost. The module 14 communicates with an existing cellular device such as the cell phone 18 that already includes a subscription thereby eliminating the requirement for an additional subscription and cellular network communication device.

The example module 14 will upon receipt of a data trouble code or other information that is indicative of a vehicle fault condition generate a signal to link with the cellular phone 18 or other compatible portable communication device. If the cell phone 18 is in use by the operator such a link will not be made or completed. However, once the cellular phone 18 is not in use the module 14 will generate the link and transmit the data trouble code or other data indicative of vehicle performance through to the wireless communication device 18.

Once the cell phone 18 has received this information, the information is automatically forwarded through the cellular network 20 to the remote location 22. Forwarding of data through the cellular phone 18 may also be selected by the operator, as a prompt. The cellular phone 18 will prompt the user to allow the user to determine if sending such a communication is desired. Further, the transmission including the data may be stored for transmission in selected desired intervals.

Once the transmission including the data indicative of vehicle performance is received at the remote location 22, the detected data trouble code can be translated and a notification to the vehicle operator or owner can be made to schedule maintenance or otherwise communicate the vehicle fault to the operator. This advanced vehicle fault detection and communication provides early detection of potential problems with the vehicle. The advanced early warning provides for early preventive maintenance that can substantially eliminate and reduce the frequency of costly repairs caused by ignoring or not detecting problems at early stages.

The diagnostic system of this example can be part of a warranty service. If the vehicle is under warranty the communication link between the module 14 through the cellular phone 18 and cellular network 20 can be automatically conducted such that the operator is not required to make any selection or be involved with the communication in any way. The diagnostic download of the data trouble code will be free of charge to the customer as part of the vehicle warranty. This will allow the dealer to be proactive in the maintenance of the vehicle to improve customer satisfaction and performance of the vehicle under warranty.

In another example method, a vehicle not under warranty may still communicate vehicle performance information for diagnosis and maintenance by a dealership or other remote maintenance facility. The module 14 generates and creates the wireless link with the cellular phone 18 and then prompts the operator if the detected trouble code should be forwarded to the remote location 22 for processing by a maintenance center or customer care facility. The download of information and the resulting diagnosis may be a service provided by a dealership or central facility for a charge to the operator. An operator would incur the charge to alert a maintenance facility or dealership of the current failures to expedite repair and maintain the vehicle in a desired operating condition.

Referring to FIG. 2 another example method utilizes the module 14 within the vehicle 10 to transmit raw data indicative of operation. The example vehicle 10 can be part of a fleet operated by a commercial carrier. As appreciated, a commercial carrier operates many vehicles to provide consistent and reliable delivery. Any unexpected vehicle failures create undesired down times for the equipment which incurs additional undesired costs. Further many carriers ship and transport items that are perishable and that can be detrimentally affected by unexpected vehicle failures.

The system schematically illustrated in FIG. 2 includes the vehicle 10 that includes the module 14 and the LF transmitter 16. The module 14 accumulates data indicative of vehicle operating conditions and transmits this information by way of the low frequency wireless link through the low frequency antenna 16 to a Bluetooth, or other low frequency compatible wireless communication device, such as the cellular phone 18. The cellular phone 18 is not part of the vehicle 10 and is of a type typically carried by an operator. By using the existing wireless communication link provided by the cell phone 18, additional subscriptions and devices are not required to be installed in the vehicle.

The low frequency transmitter provides communication within a localized area with other LF compatible devices. Data received from the control module 14 by the cellular phone 18 is then transmitted through the cellular network 30 to the remote location 22. The remote location 22 includes a data analysis device 34. The data analysis device 34 utilizes known vehicle operation parameters to compare the actual data received from a vehicle to determine if a failure condition or future failure condition exists. The continual prognostic procedure aids in preventing unexpected vehicle failures.

As appreciated, in many instances vehicle operating parameters will indicate the future failure condition of a specific vehicle system. Analysis can provide for the scheduling of maintenance for such systems to prevent vehicle operations from being affected. The advanced notice of potential failure modes is utilized to schedule maintenance of the vehicle.

Accordingly, the method and system of this invention provides for the early detection and communication of vehicle operating conditions and potential problems through an existing cellular communication link without the need for additional subscriptions of costs incurred by additional transmitters disposed within a vehicle. Further, the method utilizes an existing cellular network and wireless link compatibility to provide a predictive method of maintaining desired vehicle operation.

Although a preferred embodiment of this invention has been disclosed, a worker of ordinary skill in this art would recognize that certain modifications would come within the scope of this invention. For that reason, the following claims should be studied to determin the true scope and content of this invention.

What is claimed is:

1. A method of communicating data indicative of vehicle performance comprising the steps of:
a) detecting data indicative of a vehicle condition;
b) detecting a presence of a communication device in proximity to the vehicle;
c) communicating with the communication device the data indicative of a vehicle condition; and
d) sending a signal communicating the data to a remote location with the communication device

2. The method as recited in claim 1, wherein step a) comprises detecting a data trouble code.

3. The method as recited in claim 1, including the step of determining if the communication device is in use, and performing the step c) responsive to the communication device not being in use.

4. The method as recited in claim 1, wherein the communication device comprises a cellular phone.

5. The method as recited in claim 1, wherein the remote location comprises a maintenance facility.

6. The method as recited in claim 1, wherein step d) comprises sending the signal to a customer care center responsive to the vehicle being within a warranty period.

7. The method as recited in claim 1, wherein step d) comprises sending the signal to a customer care center responsive to operator approval.

8. The method as recited in claim 1, wherein step d) comprises sending the signal including vehicle identification information.

9. The method as recited in claim 1, wherein the communications device and the controller communicate through a short range wireless connection.

10. The method as recited in claim 1, wherein the remote location includes a system for predicting a probability of failure based on the data indicative of vehicle condition.

11. A method of reporting a data trouble code comprising the steps of:
a) detecting a data trouble code for a vehicle;
b) generating a wireless link between a controller of the vehicle and a wireless communications device proximate to the vehicle;
c) transmitting a first signal from the controller to the wireless communication device including the data trouble code; and
d) transmitting a second signal from the wireless communications device to a customer care center.

12. The method as recited in claim 11, wherein step b) comprise checking that the wireless communications device is not in use and generating the wireless link responsive to the wireless communications device not being in use.

13. The method as recited in claim 11, wherein the first signal is a wireless link comprises a short range wireless connection.

14. The method as recited in claim 11, wherein the wireless communication device comprising a cellular phone.

15. The method as recited in claim 11, wherein step d) comprises transmitting the second signal responsive to an operator approving the transmission.

16. The method as recited in claim 11, including the step of assessing a fee to an operator for transmitting the second signal to a customer care center.

17. A method of maintaining a vehicle comprising the steps of:
a) monitoring vehicle performance data indicative of current operating performance;
b) communicating the performance data to a wireless communications device proximate to the vehicle;
c) communicating the performance data from the wireless communication device to a remote location; and
d) identifying a potential failure within a desired time based on the communicated performance data.

18. The method as recited in claim 17, including scheduling preventive maintenance of the vehicle based on the identified potential failure and the desired time.

19. The method as recited in claim 17, wherein the remote location includes a diagnostic system that utilized the performance data to predict a probability of a potential failure.

20. The method as recited in claim 17, wherein the vehicle includes a module for receiving data from the vehicle system and transmitting that data to the wireless communication device.

21. The method as recited in claim 20, wherein the wireless communication device comprises a cellular phone.

22. A system for communicating vehicle performance data comprising:
a module receiving data indicative of performance from at least one vehicle system;
a transmitter for communicating data from the module to a wireless communication device proximate the vehicle; and
a remote location for receiving a transmission from the wireless communication device including data indicative of performance of at least one vehicle system.

23. The system as recited in claim 22, wherein the remote location includes a system for processing data indicative of vehicle performance.

24. The system as recited in claim 23, wherein the system determines a probability of vehicle failure based on data received indicative of vehicle performance.
